(19) United States
(12) Patent Application Publication
(10) Pub. No.: US 2008/0292364 A1
(43) Pub. Date: Nov. 27, 2008

(54) IMAGE FORMING APPARATUS, DEVELOPING APPARATUS AND DEVELOPING ROLLER FOR THE IMAGE FORMING APPARATUS

(75) Inventor: Naonori KUROGAWA, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/014,273

(22) Filed: Jan. 15, 2008

(30) Foreign Application Priority Data
May 21, 2007 (KR) 2007-49291

(51) Int. Cl. G03G 15/09

(52) U.S. Cl. 399/273

(57) ABSTRACT

A developing apparatus usable with an image forming apparatus may include a magnetic roller having disposed therein at least one magnet, and a developing roller rotatably disposed to face the magnetic roller and having a magnetic portion to contain a magnetic material that can be magnetized by a magnet of the at least one magnet disposed nearest to the developing roller.

### CROSS-REFERENCE TO RELATED APPLICATIONS

This application claims the benefit under 35 U.S.C. § 119(a) from Korean Patent Application No. 2007-49291 filed May 21, 2007 in the Korean Intellectual Property Office, the disclosure of which is incorporated herein by reference in its entirety.

### BACKGROUND OF THE INVENTION

1. Field of the Invention

The present general inventive concept relates to an image forming apparatus. More particularly, the present general inventive concept relates to an image forming apparatus to use a two-component developer to print, and developing apparatus and developing roller used by the image forming apparatus.

2. Description of the Related Art

Generally, image forming apparatuses that use toner to print an image first form an electrostatic latent image on a photosensitive medium, and then supply the toner to the electrostatic latent image using a developing apparatus to form a toner image. The toner image formed on the photosensitive medium is transferred onto a printing medium by a transferring roller. When the printing medium having the transferred toner image thereon passes through a fixing apparatus, the transferred toner image is fixed on the printing medium.

A developing apparatus to develop the electrostatic latent image formed on the photosensitive medium using a two-component developer including magnetic carriers and toner includes a developing roller to rotate and face the photosensitive medium, and a magnetic roller to supply the toner to the developing roller. The magnetic roller supplies the toner to the developing roller to form a toner layer on a surface of the developing roller. Toner of the toner layer formed on the developing roller moves to the photosensitive medium to develop the electrostatic latent image into a toner image.

However, after the developing apparatus develops the electrostatic latent image on the photosensitive medium, the developing roller generally still has toner portions thereon in which toner has not completely moved to the photosensitive medium. In other words, the developing roller has toner remaining portions on which toner does not fully move to the photosensitive medium and still remains on the developing roller. If an amount of toner that remains on a surface of the developing roller varies dependent upon portions of the surface of the developing roller, the toner remaining on the developing roller affects development of a next electrostatic latent image. That is, a development hysteresis may occur. The term “development hysteresis” refers to a phenomenon in which a developed image has traces of a previous developed image.

To solve the problem, a magnetic roller having a dual structure has been provided. That is, the magnetic roller is structured to have a non-magnetic rotation sleeve to convey toner and a stationary magnetic member that is disposed inside the rotation sleeve and has a plurality of magnets, thereby forming a toner layer with a uniform thickness on the developing roller.

However, the above-described method can cause the toner layer formed on the surface of the developing roller to have a uniform thickness, but cannot cause toner of the toner layer to have a uniform charge. Although the toner layer has a uniform thickness, unevenly charged toner of the toner layer has different development characteristics, thereby causing the development hysteresis. Therefore, the above-described method has a drawback in which it cannot prevent the development hysteresis described above.

### SUMMARY OF THE INVENTION

The present general inventive concept provides a developing roller, a developing apparatus, and an image forming apparatus that can prevent a development hysteresis from occurring when using a two-component developer.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept can substantially be achieved by providing a developing roller usable with an image forming apparatus, the developing roller including a magnetic portion magnetized by a magnet, and a non-magnetic portion disposed inside the magnetic portion.

The non-magnetic portion may be formed substantially in a cylindrical shape with a non-magnetic material.

The magnetic portion may be formed substantially in a layer shape on a surface of the non-magnetic portion.

The magnetic portion may be formed of a resin layer including a magnetic material or a magnetic metal plating layer.

The non-magnetic portion may be formed of a non-magnetic metal.

The magnetic material may include a ferrite to include at least one magnetic oxide of one element among iron (Fe), lithium (Li), beryllium (Be), calcium (Ca), strontium (Sr), and rubidium (Rb).

The magnetic material may include magnetite, Zn—Fe ferrite, Mn—Zn—Fe ferrite, Ni—Zn—Fe ferrite, Mn—Mg—Fe ferrite, Ca—Mn—Fe ferrite, Ca—Mg—Fe ferrite, Li—Fe ferrite, and Ca—Zn—Fe ferrite.

The magnetic portion may include at least one of a resistance control agent, a surface roughness control agent, and a machinery strength control agent.

The foregoing and/or other aspects and utilities of the present general inventive concept can also be achieved by providing a developing apparatus usable with an image forming apparatus including a magnetic roller having disposed therein at least one magnet, and a developing roller rotatably disposed to face the magnetic roller, and having a magnetic portion including a magnetic material that can be magnetized by a magnet of the at least one magnet disposed nearest to the developing roller.

The developing roller may include a non-magnetic portion formed substantially in a cylindrical shape with a non-magnetic material, and the magnetic portion of the developing roller may be formed substantially in a layer shape on a surface of the non-magnetic portion.

The foregoing and/or other aspects and utilities of the present general inventive concept can also be achieved by providing an image forming apparatus including a photosensitive medium, and a developing apparatus to supply the photosensitive medium with toner. The developing apparatus may include a magnetic roller having disposed therein at least one magnet, and a developing roller rotatably disposed to face the magnetic roller, and having a magnetic portion including magnetic material that can be magnetized by a magnet of the at least one magnet disposed nearest to the developing roller, wherein magnetic force lines are created between the nearest magnet of the magnetic roller and the magnetic portion of the developing roller so as to remove residual toner that remains on the developing roller.

The foregoing and/or other aspects and utilities of the general inventive concept may also be achieved by providing a method to clean residual toner from a developing roller in an image forming apparatus, the method including transferring toner from the developing roller to a photosensitive medium to form an electrostatic image, creating an area of magnetic force lines between a magnetic roller and the developing roller and rotating the developing roller through the area of magnetic lines to separate from the developing roller residual toner not transferred to the photosensitive medium.

The foregoing and/or other aspects and utilities of the general inventive concept may also be achieved by providing a computer-readable recording medium having embodied thereon a computer program to execute a method, wherein the method includes transferring toner from a developing roller to a photosensitive medium to form an electrostatic image, creating an area of magnetic force lines between a magnetic roller and the developing roller and rotating the developing roller through the area of magnetic lines to separate from the developing roller residual toner not transferred to the photosensitive medium.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a conceptual view illustrating an image forming apparatus according to an embodiment of the present general inventive concept;

FIG. 2 is a sectional view schematically illustrating a developing roller for an image forming apparatus according to an embodiment of the present general inventive concept;

FIG. 3 is a view schematically illustrating a developing roller and a magnetic roller of a developing apparatus for an image forming apparatus according to an embodiment of the present general inventive concept;

FIG. 4 is a conceptual view illustrating a magnetic brush formed between a developing roller and a magnetic roller in a developing apparatus for an image forming apparatus according to an embodiment of the present general inventive concept; and

FIG. 5 is a flowchart illustrating a method to clean residual toner from a developing roller in an image forming apparatus according to an exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

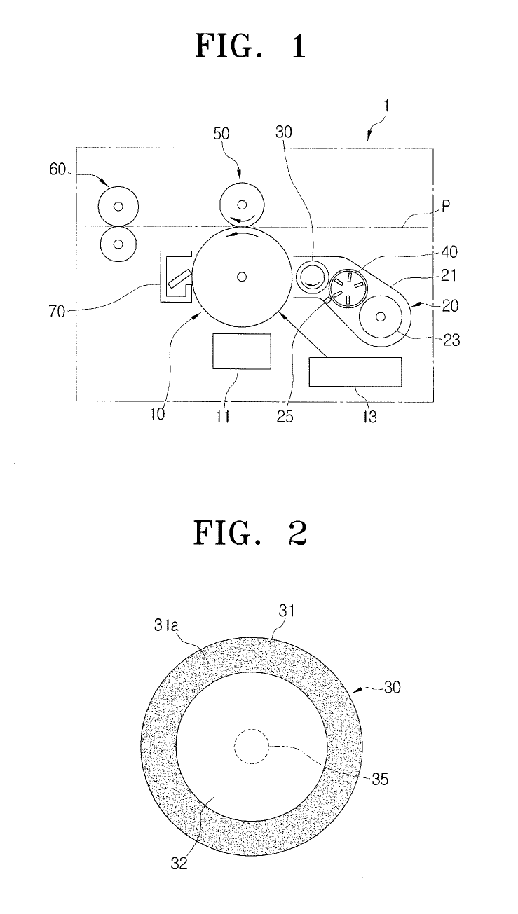

FIG. 1 is a conceptual view illustrating an image forming apparatus 1 according to an embodiment of the present general inventive concept, and FIG. 2 is a sectional view schematically illustrating a developing roller 30 capable of being used in the image forming apparatus 1 of FIG. 1.

Referring to FIG. 1, the image forming apparatus 1 according to an embodiment of the present general inventive concept includes a photosensitive medium 10, a developing apparatus 20, a transferring roller 50, and a fixing apparatus 60.

The photosensitive medium 10 is an image carrier on which a predetermined image is formed. In this embodiment, a photosensitive drum is used as the photosensitive medium 10. The photosensitive medium 10 is rotatably disposed at a main body (not illustrated) of the image forming apparatus 1. A charging unit 11, a light exposure unit 13, the developing apparatus 20, the transferring roller 50, and a toner cleaning unit 70 are disposed around the photosensitive medium 10.

The charging unit 11 charges a surface of the photosensitive medium 10 by a predetermined voltage. The light exposure unit 13 emits a laser beam corresponding to printing data to form an electrostatic latent image on the charged surface of the photosensitive medium 10.

The developing apparatus 20 supplies toner T1 to the photosensitive medium 10 to develop the electrostatic latent image formed on the photosensitive medium 10 into a toner image, and includes the developing roller 30, a magnetic roller 40, and a housing 21.

The developing roller 30 is rotatably disposed at the housing 21 to face the photosensitive medium 10, and supplies the photosensitive medium 10 with the toner T1 conveyed from the magnetic roller 40. That is, the developing roller 30 is disposed at an opening of the housing 21.

Referring to FIG. 2, the developing roller 30 is formed substantially in a cylindrical shape, and has a layer structure with at least two layers 31 and 32. In this embodiment, as illustrated in FIG. 2, the developing roller 30 is configured of a non-magnetic portion 32 and a magnetic portion 31 formed on an outer circumferential surface of the non-magnetic portion 32.

The non-magnetic portion 32 forms an inner layer of the developing roller 30. The non-magnetic portion 32 is formed substantially in a cylindrical shape and made of a non-magnetic material. A non-magnetic metal may be used as the non-magnetic material. Also, a developing roller shaft 35 is disposed at a center of each of both side surfaces of the non-magnetic portion 32 of the developing roller 30. The developing roller shaft 35 is rotatably supported with respect to the housing 21, thereby allowing the developing roller 30 to rotate. Alternatively, the developing roller shaft 35 may be formed to go through the center of the non-magnetic portion 32 of the developing roller 30.

The magnetic portion 31 forms an outer layer of the developing roller 30, and is formed in a layer shape on the surface of the non-magnetic portion 32. The magnetic portion 31 includes a magnetic material 31a that may be magnetized by a magnet that is disposed outside the developing roller 30 and spaced apart from the developing roller 30. The magnetic material 31a does not have magnetism by itself, but can become magnetized only by a magnetic force applied from the outside of the magnetic material 31a. Therefore, when an outside magnet is disposed separately from and outside the developing roller 30, magnetic force lines are formed between the magnetic portion 31 of the developing roller 30 and the outside magnet.

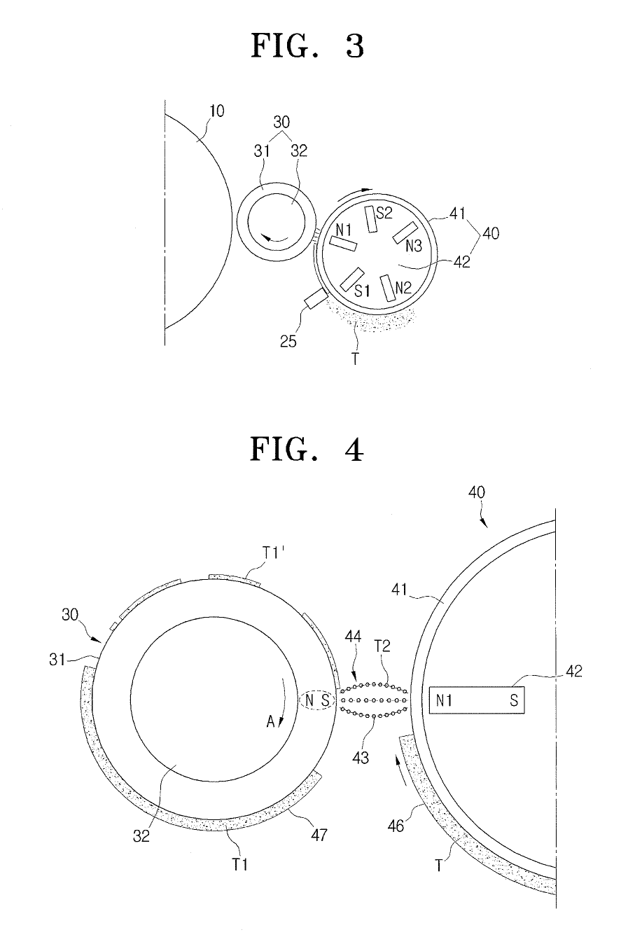

In this embodiment, the magnetic portion 31 of the developing roller 30 includes the magnetic material 31a that can be magnetized by a magnet N1 of the magnetic roller 40 (FIG. 3). The magnetic material 31a may be formed in powder to be uniformly distributed in the magnetic portion 31. The magnetic portion 31 may be formed so that the outer circumferential surface of the non-magnetic portion 32 of the developing roller 30 is coated with a resin containing the magnetic material 31a. Alternatively, the magnetic portion 31 may be formed by plating the outer circumferential surface of the non-magnetic portion 32 of the developing roller 30 with the magnetic metal. That is, the magnetic portion 31 may be formed in a magnetic layer that is formed of either of a resin coating layer containing the magnetic material 31a or a magnetic metal plating layer.

The magnetic material 31a that can be contained in the magnetic portion 31 of the developing roller 30 is not limited. Various known magnetic materials can be used as the magnetic material 31a of the magnetic portion 31. For example, ferrite containing at least one magnetic oxide of one element among iron (Fe), lithium (Li), beryllium (Be), calcium (Ca), strontium (Sr), and rubidium (Rb) can be used as the magnetic material 31a.

In detail, iron oxide such as magnetite, Zn—Fe ferrite, Mn—Zn—Fe ferrite, Ni—Zn—Fe ferrite, Mn—Mg—Fe ferrite, Ca—Mn—Fe ferrite, Ca—Mg—Fe ferrite, Li—Fe ferrite, Ca—Zn—Fe ferrite, etc., can be used as the magnetic material 31a.

Additionally, the magnetic portion 31 of the developing roller 30 may include at least one of a resistance control agent, a surface roughness control agent, and a machinery strength control agent to control a physical performance of the developing roller 30.

The types of the coating resin that forms the magnetic portion 31 of the developing roller 30 and contains the magnetic material 31a are not limited. Various types of resin can be used as the coating resin as long as it has physical and chemical characteristics required by the developing roller 30.

FIG. 3 is a view schematically illustrating a developing roller and a magnetic roller of a developing apparatus for an image forming apparatus according to an embodiment of the present general inventive concept. Referring to FIG. 3, the magnetic roller 40 is rotatably disposed at the housing 21 to face the developing roller 30, and includes a rotation sleeve 41 and a stationary magnetic member 42. The rotation sleeve 41 is formed substantially in a hollow cylindrical shape, and disposed rotatably with respect to the housing 21. The stationary magnetic member 42 is disposed inside the rotation sleeve 41 and has a plurality of magnets N1, N2, N3, S1, and S2 to form magnetic force lines on an outer circumferential surface of the rotation sleeve 41.

In this embodiment, the stationary magnetic member 42 has five magnets N1, N2, N3, S1, and S2. The five magnets include three north pole magnets N1, N2, and N3 and two south pole magnets S1 and S2 disposed between the north pole magnets N1, N2, and N3. The N1 pole magnet is arranged at a position nearest to the developing roller 30 to magnetize the magnetic material 31a contained in an area of the magnetic portion 31 of the developing roller 30 to face the N1 pole magnet. The N2 and N3 pole magnets are arranged at both sides of the N1 pole magnet. The S1 pole magnet is arranged between the N1 and N2 pole magnets, and the S2 pole magnet is arranged between the N1 and N3 pole magnets.

Some of the two-component developer T contained in the housing 21 is attached on the outer surface of the rotation sleeve 41 by the magnetic force lines, which are formed on the outer surface of the rotation sleeve 41 of the magnetic roller 40 by the north and south pole magnets N1, N2, N3, S1, and S2 of the stationary magnetic member 42, and then, is conveyed toward the developing roller 30.

Referring to FIGS. 1 and 3, the housing 21 rotatably supports the developing roller 30 and the magnetic roller 40, and stores the two-component developer T to be supplied to the photosensitive medium 10. The two-component developer T includes magnetic carriers T2 and toner T1. An agitator 23 that agitates the two-component developer T to charge the toner T1 may also be disposed under the magnetic roller 40 inside the housing 21.

A doctor blade 25 may be disposed at the housing 21 substantially parallel to the magnetic roller 40 in an axial direction of the magnetic roller 40 to regulate a thickness of the developer layer formed on the surface of the magnetic roller 40. The doctor blade 25 is disposed upstream of an area in which the developing roller 30 and the magnetic roller 40 face each other in a rotational direction of the magnetic roller 40. There is a gap between a front end of the doctor blade 25 and the surface of the rotation sleeve 41 of the magnetic roller 40.

Additionally, a voltage is applied to the developing roller 30 and the magnetic roller 40 to create an electrical potential difference so that when toner T1 attached on the surface of the rotation sleeve 41 of the magnetic roller 40 comes near the developing roller 30, the toner T1 is moved to the developing roller 30 by electrostatic force between the developing roller 30 and the magnetic roller 40. That is, a bias is applied to the developing roller 30 and the magnetic roller 40 in a direction in which the electrostatic force causes the toner T1 to move from the magnetic roller 40 to the developing roller 30.

The transferring roller 50 is rotatably disposed to face the photosensitive medium 10, and causes the toner image formed on the photosensitive medium 10 to be transferred onto a printing medium P fed from the printing medium feeding unit (not illustrated).

The fixing apparatus 60 includes a heating roller and a pressure roller, and causes the transferred toner image to be fixed on the printing medium P.

The toner cleaning unit 70 is disposed at a side of the photosensitive medium 10 to remove waste toner that remains on the surface of the photosensitive medium 10 after the toner image is transferred onto the printing medium P by the transferring roller 50.

Hereinafter, operation of the image forming apparatus 1 according to an embodiment of the present general inventive concept will be explained with reference to FIGS. 1 to 4.

When receiving a printing command and printing data, a control unit (not illustrated) of the image forming apparatus 1 operates the charging unit 11 to charge the photosensitive medium 10 by a predetermined voltage. Then, the control unit controls the light exposure unit 13 to emit a laser beam, thereby forming an electrostatic latent image corresponding to the printing data on the charged photosensitive medium 10.

When the photosensitive medium 10 rotates for the electrostatic latent image on the photosensitive medium 10 to face the developing roller 30, the toner T1 attached on the surface of the developing roller 30, that is, the surface of the magnetic portion 31 of the developing roller 30 is moved to the photosensitive medium 10 by the electrostatic force to develop the electrostatic latent image into a toner image.

Residual toner T1′ that remains on the surface of the developing roller 30 and does not move onto the photosensitive medium 10 is separated from the surface of the developing roller 30 and collected toward the magnetic roller 40 by a magnetic brush 44 formed between the magnetic portion 31 of the developing roller 30 and the magnetic roller 40.

In the developing apparatus 20 of the image forming apparatus 1 according to an embodiment of the present general inventive concept, operation in which the toner T1 is moved onto the photosensitive medium 10 and the residual toner T1′ to remain on the developing roller 30 is removed therefrom will be explained hereinafter.

The two-component developer T stored in the housing 21 is conveyed toward the developing roller 30 by being attached to the rotation sleeve 41 of the magnetic roller 40. Accordingly, the two-component developer T is attached on the rotation sleeve 41 by the magnetic force lines formed on the surface of the rotation sleeve 41 of the magnetic roller 40 due to the stationary magnetic member 42 of the magnetic roller 40, thereby forming a developer layer 46 on the rotation sleeve 41 of the magnetic roller 40. When the rotation sleeve 41 rotates, the developer layer 46 on the rotation sleeve 41 passes under the doctor blade 25 to be regulated by a predetermined thickness.

The rotation sleeve 41 of the magnetic roller 40 rotates for the developer layer 46 thereon to come near the developing roller 30. The toner T1 of the two-component developer T that forms the developer layer 46 is moved to the developing roller 30 by the electrostatic force that operates between the developing roller 30 and the magnetic roller 40. Accordingly, a toner layer 47 on the surface of the developing roller 30 is formed.

The developing roller 30 rotates for the toner layer 47 thereon to face the photosensitive medium 10. The toner T1 that forms the toner layer 47 on the developing roller 30 is moved to the photosensitive medium 10 by the electrostatic force between the photosensitive medium 10 and the developing roller 30. Accordingly, the electrostatic latent image is developed on the photosensitive medium 10 into the toner image.

When the developing roller 30 continues to rotate, the residual toner T1′ that remains on the developing roller 30 and does not move to the photosensitive medium 10 is conveyed toward the area in which the developing roller 30 and the magnetic roller 40 face each other. At the area at which the developing roller 30 faces the magnetic roller 40, the magnetic brush 44 separates the residual toner T1′ that remains on the magnetic portion 31 of the developing roller 30 from the magnetic portion 31 so that the separated residual toner T1′ is collected toward the magnetic roller 40. That is, when the developing roller 30 rotates in a direction of arrow A as illustrated in FIG. 4, the residual toner T1′ that remains on the magnetic portion 31 of the developing roller 30 can be separated from the magnetic portion 31 through the magnetic brush 44.

The magnetic brush 44 is formed as described below. The N1 pole magnet that is disposed at a position nearest to the developing roller 30 among the stationary magnetic member 42, as illustrated in FIG. 4, magnetizes the magnetic material 31a of an area of the magnetic portion 31 of the developing roller 30 to face the N1 pole magnet into S pole opposite to the N1 pole magnet. As a result, magnetic force lines 43 are created between the N1 pole magnet of the magnetic roller 40 and the S pole formed at the area of the magnetic portion 31 of the developing roller 30, so the magnetic carriers T2 of the two-component developer T move along the magnetic force lines 43 to form the magnetic brush 44 between the developing roller 30 and the magnetic roller 40. The magnetic brush 44 is formed between the magnetic pole N1 of the magnetic roller 40 and the magnetic portion 31 of the developing roller 30 to contain the powdered magnetic material 31a, and the magnetic brush 44 is formed to cover a broader area than the conventional developing roller with a surface formed of a non-magnetic portion. Therefore, the developing apparatus 20 according to this embodiment can effectively remove the residual toner T1′ that remains on the developing roller 30.

When the photosensitive medium 10 continues to rotate, the toner image formed on the photosensitive medium 10 is transferred onto the printing medium P by the transferring roller 50. The printing medium P enters between the transferring roller 50 and the photosensitive medium 10 from the printing medium feeding unit (not illustrated).

The printing medium P with the transferred toner image thereon is conveyed to the fixing apparatus 60. While passing between the pressure roller and the heating roller of the fixing apparatus 60, the toner image is fixed onto the printing medium P. The discharging apparatus (not illustrated) discharges the printing medium P with the toner image fixed thereon outside the image forming apparatus 1.

After the toner image on the photosensitive medium 10 is transferred onto the printing medium P, the waste toner to remain on the photosensitive medium 10 is removed from the photosensitive medium 10 by the toner cleaning unit 70.

After that, the charging unit 11 charges the photosensitive medium 10 by a predetermined voltage, so the above-described process is repeated to perform a print operation.

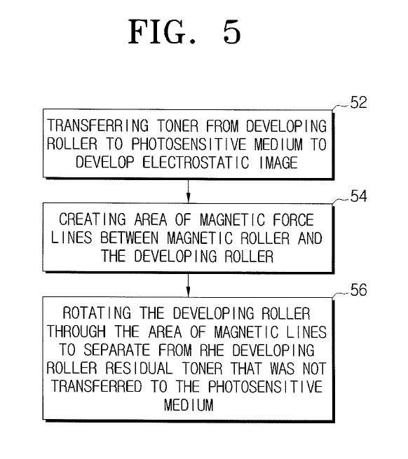

FIG. 5 is a flowchart illustrating a method to clean residual toner from a developing roller in an image forming apparatus according to an exemplary embodiment of the present general inventive concept. Referring to FIG. 5, in operation 52, toner is transferred from the developing roller to a photosensitive medium to develop an electrostatic image. In operation 54, an area of magnetic force lines is created between a magnetic roller and the developing roller. In operation 56, the developing roller is rotated through the area of magnetic force lines to separate from the developing roller the residual toner that was not transferred to the photosensitive medium.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

With respect to the image forming apparatus, the developing apparatus for the image forming apparatus, and the developing roller for the image forming apparatus according to various embodiments of the present general inventive concept as described above, a broader magnetic brush is formed between the developing roller and the magnetic roller, thereby preventing the development hysteresis from occurring when the two-component developer is used.

Furthermore, with respect to the image forming apparatus, the developing apparatus for the image forming apparatus, and the developing roller for the image forming apparatus according to various embodiments of the present general inventive concept, the magnetic portion of the developing roller may be formed by coating a resin containing the magnetic material thereon or plating a magnetic metal thereon. Therefore, the developing roller has a simple structure, thereby decreasing manufacturing costs thereof.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A developing roller usable with an image forming apparatus, the developing roller comprising:
a magnetic portion magnetized by a magnet; and
a non-magnetic portion disposed inside the magnetic portion.

2. The developing roller of claim 1, wherein the non-magnetic portion is formed substantially in a cylindrical shape with a non-magnetic material.

3. The developing roller of claim 2, wherein the magnetic portion is formed substantially in a layer shape on a surface of the non-magnetic portion.

4. The developing roller of claim 3, wherein the magnetic portion is formed of a resin layer including a magnetic material or a magnetic metal plating layer.

5. The developing roller of claim 3, wherein the non-magnetic portion is formed of a non-magnetic metal.

6. The developing roller of claim 4, wherein the magnetic material comprises:
a ferrite to include at least one magnetic oxide of one element among iron (Fe), lithium (Li), beryllium (Be), calcium (Ca), strontium (Sr), and rubidium (Rb).

7. The developing roller of claim 4, wherein the magnetic material comprises:
magnetite, Zn—Fe ferrite, Mn—Zn—Fe ferrite, Ni—Zn—Fe ferrite, Mn—Mg—Fe ferrite, Ca—Mn—Fe ferrite, Ca—Mg—Fe ferrite, Li—Fe ferrite, and Ca—Zn—Fe ferrite.

8. The developing roller of claim 4, wherein the magnetic portion comprises:
at least one of a resistance control agent, a surface roughness control agent, and a machinery strength control agent.

9. A developing apparatus usable with an image forming apparatus, the developing apparatus comprising:
a magnetic roller having disposed therein at least one magnet; and
a developing roller rotatably disposed to face the magnetic roller, and having a magnetic portion including a magnetic material that can be magnetized by a magnet of the at least one magnet disposed nearest to the developing roller.

10. The developing apparatus of claim 9, wherein the developing roller comprises:
a non-magnetic portion formed substantially in a cylindrical shape with a non-magnetic material, wherein the magnetic portion of the developing roller is formed substantially in a layer shape on a surface of the non-magnetic portion.

11. The developing apparatus of claim 10, wherein the magnetic portion of the developing roller is formed of a resin layer including the magnetic material or a magnetic metal plating layer.

12. The developing apparatus of claim 10, wherein the non-magnetic portion of the developing roller is formed of a non-magnetic metal.

13. The developing apparatus of claim 10, wherein the magnetic material comprises:
a ferrite to include at least one magnetic oxide of one element among iron (Fe), lithium (Li), beryllium (Be), calcium (Ca), strontium (Sr), and rubidium (Rb).

14. The developing apparatus of claim 10, wherein the magnetic material comprises:
magnetite, Zn—Fe ferrite, Mn—Zn—Fe ferrite, Ni—Zn—Fe ferrite, Mn—Mg—Fe ferrite, Ca—Mn—Fe ferrite, Ca—Mg—Fe ferrite, Li—Fe ferrite, and Ca—Zn—Fe ferrite.

15. An image forming apparatus, comprising:
a photosensitive medium; and
a developing apparatus to supply the photosensitive medium with toner; wherein the developing apparatus comprises:
a magnetic roller having disposed therein at least one magnet; and
a developing roller rotatably disposed to face the magnetic roller, and having a magnetic portion include a magnetic material that can be magnetized by a magnet of the at least one magnet disposed nearest to the developing roller,
wherein magnetic force lines are created between the nearest magnet of the magnetic roller and the magnetic portion of the developing roller to remove residual toner that remains on the developing roller.

16. The image forming apparatus of claim 15, wherein the developing roller comprises:
a non-magnetic portion formed substantially in a cylindrical shape with a non-magnetic material, wherein the magnetic portion of the developing roller is formed substantially in a layer shape on a surface of the non-magnetic portion.

17. The image forming apparatus of claim 16, wherein the magnetic portion of the developing roller is formed of a resin layer including a magnetic material or a magnetic metal plating layer.

18. The image forming apparatus of claim 16, wherein the non-magnetic portion of the developing roller is formed of a non-magnetic metal.

19. The image forming apparatus of claim 16, wherein the magnetic material comprises:
a ferrite to include at least one magnetic oxide of one element among iron (Fe), lithium (Li), beryllium (Be), calcium (Ca), strontium (Sr), and rubidium (Rb).

20. The image forming apparatus of claim 16, wherein the magnetic material comprises:
magnetite, Zn—Fe ferrite, Mn—Zn—Fe ferrite, Ni—Zn—Fe ferrite, Mn—Mg—Fe ferrite, Ca—Mn—Fe ferrite, Ca—Mg—Fe ferrite, Li—Fe ferrite, and Ca—Zn—Fe ferrite.

21. A method to clean residual toner from a developing roller in an image forming apparatus, the method comprising:
transferring toner from the developing roller to a photosensitive medium to develop an electrostatic image;
creating an area of magnetic force lines between a magnetic roller and the developing roller; and
rotating the developing roller through the area of magnetic force lines to separate from the developing roller residual toner not transferred to the photosensitive medium.

22. The method of claim 21, wherein creating the area of magnetic force lines between the magnetic roller and the developing roller comprises:
providing the magnet on the stationary magnetic member of the magnetic roller nearest to the developing roller to magnetize the magnetic portion of the developing roller.
